(19) United States
(12) Patent Application Publication
(10) Pub. No.: US 2026/0185508 A1
(43) Pub. Date: Jul. 2, 2026

(54) LOW-GRADE HEAT ENGINE SYSTEM

(71) Applicant: First Pecos, LLC, Monahans, TX (US)

(72) Inventor: Leon A. Greenblatt, Monahans, TX (US)

(21) Appl. No.: 19/123,142

(22) PCT Filed: Oct. 23, 2023
(86) PCT No.: PCT/US2023/077503

§ 371 Date: Apr. 22, 2025

Related U.S. Application Data
(60) Provisional application No. 63/422,087, filed on Nov. 3, 2022.

(51) Int. Cl. F03G 7/04; F01K 23/04; F03G 4/00; H02K 7/18

(52) U.S. Cl. CPC F03G 7/04; F01K 23/04; F03G 4/00; H02K 7/1823

(57) ABSTRACT

A low-grade heat engine system powered by a source fluid containing low-grade heat. A primary loop contains a primary working fluid. The primary working fluid has a boiling point below the source fluid. A first heat exchanger is configured to transfer heat from the source fluid into the primary working fluid and create a gas phase of the primary working fluid. A thermosiphon portion of the primary loop is arranged to direct the gas phase of the primary working fluid in a direction opposite to gravitational force. A primary hydro turbine driven by a liquid phase of the primary working fluid as the liquid phase is driven with the gravitational force.

### PRIORITY CLAIM AND REFERENCE TO RELATED APPLICATION

The application claims priority under 35 U.S.C. § 119 and all applicable statutes and treaties from prior U.S. provisional application Ser. No. 63/422,087, which was filed Nov. 3, 2022.

### FIELD

A field of the invention is heat engines. Systems of the invention are applicable to a natural or system source of low-grade heat, e.g., low grade geothermal heat, condensing steam, cooling water or combustion exhaust.

### BACKGROUND

Low-grade heat energy recovery systems are of interest, for example to recover low-grade waste heat from industrial processes. Industrial sources of low-grade heat include flue gases from boiler systems, waste heat from compression cooling systems, condensate from steam heating systems, and spent cooling water from cooling systems. Many other industrial processes produce low-grade heat, including petrochemical processes.

Other sources of low-grade geothermal heat include wells of various types. Spent oil wells are one example. After being capped, the wells are not used but do provide a potential energy source in the form of the low-grade geothermal heat. Presently, commercially feasible solutions have shown limited efficiency and therefore limited application in practice. Accordingly, many industrial processes have waste heat that is dissipated into the atmosphere and wasted despite its potential as an abundant green energy source.

One known approach for generating energy from low-grade heat is based upon organic Rankine cycle. A typical system based upon the Rankine cycle includes a working fluid in a closed loop. Via an evaporator, a low-grade heat source heats the working fluid which drives a generator through an expander. A condenser supplied with cooling medium cools the working fluid, which is then pumped by an active pump to a required pressure for the cycle and back to the evaporator. Efficiencies of organic Rankine cycle systems are limited by achievable pressure of the working fluid. The systems require very high capital expenditures.

A few of these systems have been implemented and operating. Units manufactured by Turboden have been operated by iron and steel foundries. These units have output powers ranging from 555 kW gross electric power output to 2700 kW gross electric power output. An Opcon Powerbox unit was installed in Sweden and powered by waste heat from a pulp mill. Units made by Exergy have been employed to recover energy from glass manufacturing plants.

Another known approach for generating energy is based upon organic Kalina cycle. Both Rankine and Kalina cycles work well with higher temperature waste heat sources but are not practical for operating for a low grade heat source.

### SUMMARY OF THE INVENTION

A preferred embodiment provides a low-grade heat engine system powered by a source fluid containing low-grade heat. A primary loop contains a primary working fluid. The primary working fluid has a boiling point below the source fluid. A first heat exchanger is configured to transfer heat from the source fluid into the primary working fluid and create a gas phase of the primary working fluid. A thermosiphon portion of the primary loop is arranged to direct the gas phase of the primary working fluid in a direction opposite to gravitational force. A primary hydro turbine driven by a liquid phase of the primary working fluid as the liquid phase is driven with the gravitational force.

### BRIEF DESCRIPTION OF THE DRAWINGS

FIG. 1 is a diagram of a preferred low-grade heat efficient heat engine system in cross-section;

FIG. 2 is a schematic diagram that shows a series arrangement of heat engine systems consistent with FIG. 1;

FIG. 3 is a schematic diagram that shows a series and parallel arrangement of heat engine systems consistent with FIG. 1;

FIG. 4 shows a heat engine system of the invention applied to a plugged oil or gas well;

FIGS. 5A & 5B show heat engine systems consistent with FIG. 1 with geothermal wells as low-grade heat sources applied to a mountain or hill slope; and

FIGS. 6A and 6B show multiple heat engine systems consistent with FIG. 1 applied in a cooling tower.

### DETAILED DESCRIPTION OF THE PREFERRED EMBODIMENTS

A preferred embodiment low-grade heat efficient heat engine system includes interfaces with source fluid providing the low-grade heat via a heat exchanger. A preferred system includes a primary closed loop containing a primary working fluid, the primary working fluid having a boiling point below the source fluid. A first heat exchanger is configured and arranged to direct heat from the source fluid into the primary working fluid and create a gas phase of the primary working fluid. A thermosiphon portion of the primary closed loop is arranged to direct the gas phase of the primary working fluid in a direction opposite to gravitational force. A second heat exchanger is at an upper (top) portion of the primary closed loop to extract heat from the gas phase of the primary working fluid and convert the primary working fluid into a liquid phase. A primary hydro turbine is arranged below the second heat exchanger in the direction of gravitational force such that gravitational force acting on the liquid phase drives the hydro turbine.

Systems of the invention have many applications to recover energy from natural and other sources of low-grade heat. Low-grade heat sources can include, for example, low-grade geothermal heat, condensing steam, cooling water or combustion exhaust. Systems of the invention can be used in lieu of a cooling tower to switch the cooling tower from a mere necessary expense in a system to an ancillary power source while also conserving cooling water through the recycling of the cooled water used as a heat source instead of emitting steam or warmed water to the surrounding environment.

Example working fluids include the following:

| | | | | Density |
|---|---|---|---|---|
| | | | BP | grams |
| | | | deg C. | per cc |
| 1,1-Dichloro-1- | R-141b | | 32 | 1.25 |
| fluoroethane | | | | |
| Dibromotetra- | R-114B2 | Halon 2402 | 47.2 | 2.18 |
| fluoroethane | | | | |
| 1,1,2-Trichloro-1,2,2- | CFC-113 | Freon 113 | 47.7 | 1.56 |
| trifluoroethane | | | | |
| Perfluorohexane | FC-72 | R-5-1-14 | 56 | 1.69 |
| 1,1-Dichloroethane | CFC-150a | | 57.2 | 1.2 |
| Bromochloromethane | Halon 1011 | | 68 | 1.99 |
| Perfluoroheptane | | | 81 | 1.745 |
| Perfluoropentane | | | | |

A working fluid can be selected with reference to the low-grade heat source such that its boiling point is lower. Fluids are ideally dense, nontoxic and nonflammable. The fluids are isolated in the system. Subsequent series systems of the invention have successively lower boiling point working fluids.

Preferred embodiments of the invention will now be discussed with respect to experiments and drawings. Broader aspects of the invention will be understood by artisans in view of the general knowledge in the art and the description of the experiments that follows.

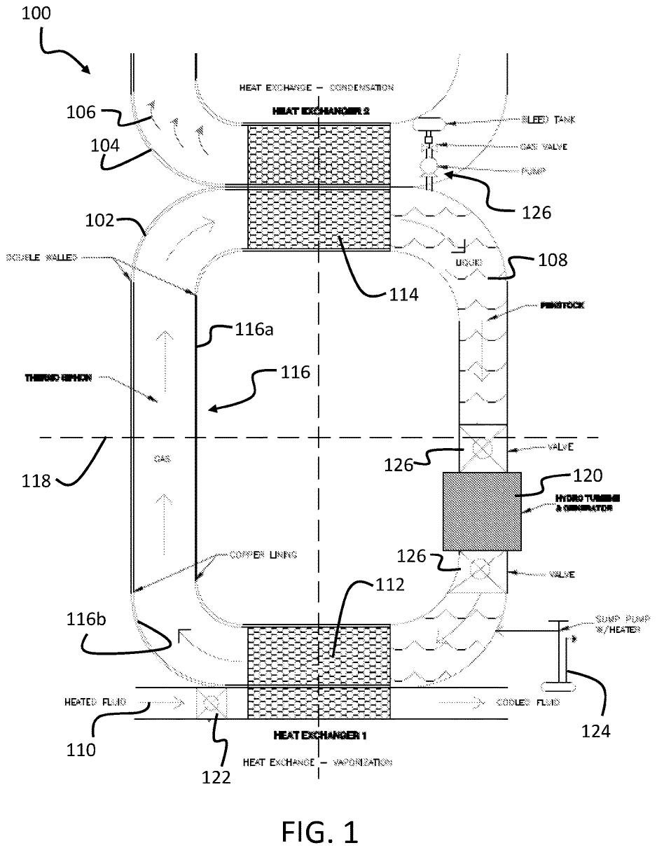

FIG. 1 shows a preferred low-grade heat efficient heat engine system 100 in cross-section. A primary closed loop 102 is shown in full, and a partial view is shown of a secondary loop 104. The secondary loop 104 contains a lower boiling point fluid 106 that a primary working fluid 108 contained in the primary loop 102.

The primary working fluid 108 has a boiling point below that of source fluid 110 that transfers heat to the primary working fluid 108 via first heat exchanger 112, which is configured and arranged to direct heat from the source fluid 110 into the primary working fluid 108 and create a gas phase of the primary working fluid 108. Similarly, the primary working fluid 108 transfers heat via a second heat exchanger 114 to the lower boiling point fluid 106.

A thermosiphon portion 116 of the primary closed loop 102 is arranged to direct a gas phase of the primary working fluid 108 in a direction opposite to gravitational force. The second heat exchanger 114 is at an upper (top) portion of the primary closed loop 102 to extract heat from the gas phase of the primary working fluid 108 and convert the primary working fluid 108 into a liquid phase. Condensing of the primary working fluid 108 provides a vacuum pull of the gas phase of the primary working fluid 108 up the thermosiphon portion 116. The heat extracted in the second heat exchanger 114 at the top of the cycle can be used to supply heat to a similar heat engine or to be used to supply heat energy to a device or an environment.

The thermosiphon portion 116 is preferable insulated, such as by having a double wall 116a when the surrounding environment is lower temperature than the gas phase of the primary working fluid. The double wall 116a and/or other insulation aid in inhibiting cooling of the primary working fluid in its gas phase so that most of its energy is retained to be transferred by the second heat exchange 114 to the lower boiling point fluid 106. Dashed line 118 indicates a midline of the primary loop 102.

A thermally lined portion 116b of the primary loop 102 adjacent the first heat exchanger 112 is preferably lined with a good thermal conductor, such as copper so that an inner lumen of the primary closed loop is heated to help maintain the gas phase of the primary working fluid 108. The thermally lined portion can extend throughout the inner wall of the primary closed loop between the first heat exchanger 112 and the second heat exchanger 114. On the other hand, If the thermosiphon is in a hot surrounding environment, the thermosiphon portion 116 can include a heat conducting wall configured to conduct heat from the surrounding environment to the gas phase of the primary working fluid 108.

A primary hydro turbine 120 is arranged in the primary closed loop 102 below the second heat exchanger 114 in the direction of gravitational force such that gravitational force acting on the liquid phase of the primary working fluid 108 drives the primary hydro turbine 120.

Very high-efficiency conversion is possible because the heat engine system 100 requires no power other than the low-grade heat source. The only active device is the hydro turbine 120, which is driven by the primary working fluid 108 in its liquid phase assisted by gravitational force. There are no external pumps that need to be driven by external power for the heat engine system 100 to operate. Fiberglass, aluminum and steel, including stainless and coated steel, are preferred example materials for the loops in the low-grade heat efficient heat engine system 100.

The height of the thermosiphon 116 can be set such that the efficiency of the system is set to the Carnot efficiency. The efficiency is mgh/(mgh+Enthalpy of vaporization of the primary working fluid 108) where m is the unit mass of the fluid g is the gravity constant and h is height of the thermosiphon.

The heated fluid 110 can be from a biomass-to-liquid fuel system, a generating station, a pyrolysis and gasification system and many other processes that provide a heated source fluid as a byproduct of normal operation. A valve 122 permits a shut off the source heated fluid 110 to the primary loop for maintenance and other operational purposes as determined by an operator. A sump pump 124 with a heater prevents freezing and provides a maintenance function to allow draining of the working fluid 108. Valves 126 on inflow and outflow sides of the hydro turbine permit infrequent maintenance of the hydroturbine. The primary loop 102 can also include an assembly (not shown) with a pump, gas valve and bleed tank, also for maintenance of the primary loop 102, including cleaning, repair, replacement of working fluid, etc.

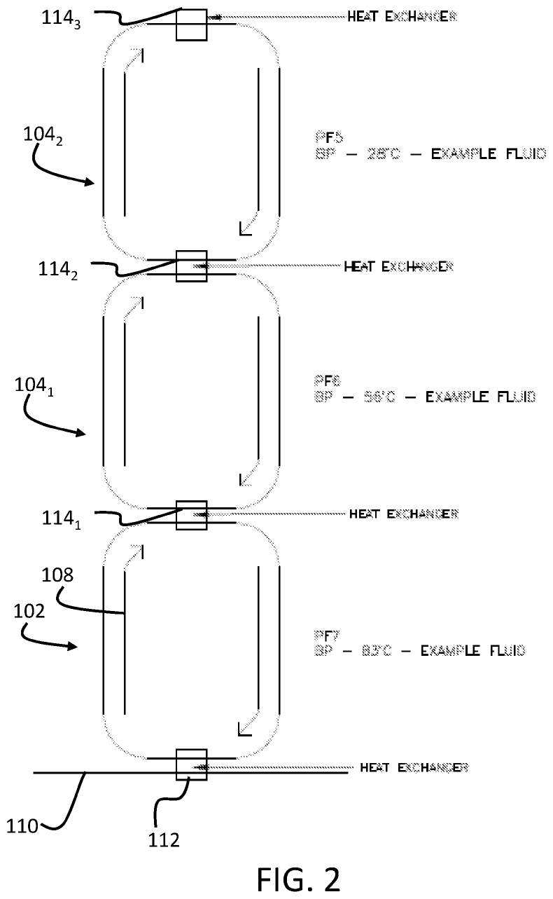

FIG. 2 shows a series arrangement of heat engine systems 100 consistent with FIG. 1, illustrated in schematic fashion to emphasize the series arrangement. The lowest system consistent with FIG. 1 is powered by a low-grade heat source to drive the primary working fluid 108 into its gas phase as discussed above. Numerous subsequent loops 104₁-104ₓ can be used so long as each has a working fluid with a lower boiling point of that of the working fluid of a previous loop 102 or 104ₓ. Each subsequent loop contains a lower boiling point working fluid than the previous one in the series chain.

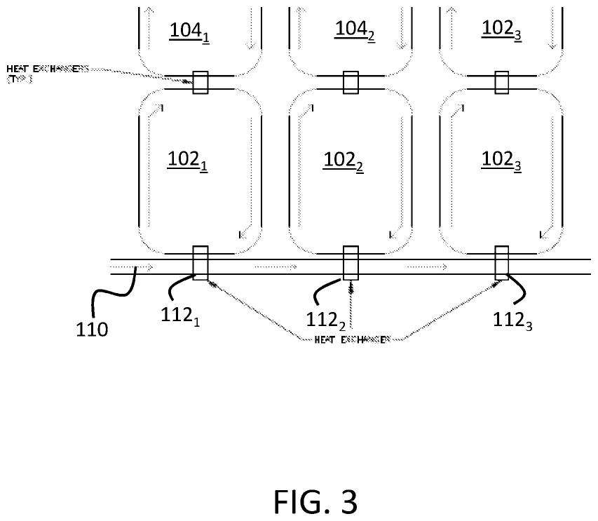

FIG. 3 shows a series and parallel arrangement of heat engine systems 100 consistent with FIG. 1, illustrated in schematic fashion to emphasize the series and parallel arrangement. The three parallel systems are powered by the same low-grade heat source 100 through each of their first heat exchangers 112₁-112ₓ. Each of the secondary loops 104₁-104ₓ is powered by a respective second heat exchanger 114₁-114ₓ. Working fluid in the secondary loops 104₁-104ₓ has a lower boiling point than primary working fluid in each of the primary loops 102₁-102ₓ.

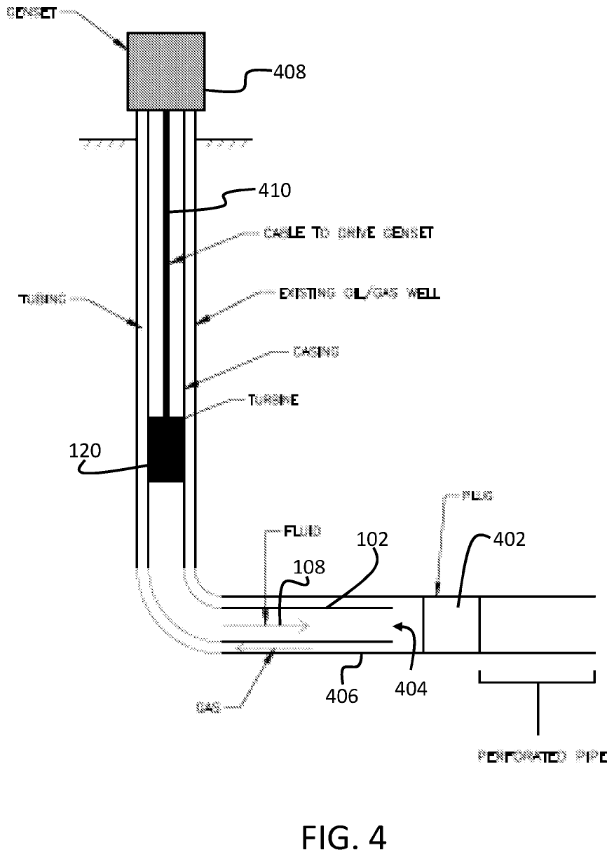

FIG. 4 shows a preferred application for the heat engine system 100 of FIG. 1 to a plugged oil or gas well. The heat engine system 100 is applied to the outflow side of a well plug 402 of a plugged oil or gas well. The primary loop 102 is formed by inserting a tube into the well that has an opening 404 toward the plug 402. The plug 402 serves as a first heat exchanger, as it transfers heat from its opposite side to the working fluid 108 to convert its liquid phase exiting the opening 404 to a gas phase. A hydro turbine 120 is within the primary loop 102 and is driven by the fluid state of the primary working fluid 108 and gravity. The working fluid 108 flows in a closed loop. The thermosiphon portion 116 is between the primary loop 102 and an existing well casing 406 (gas stage of working fluid flows up in the gap between tubing of the primary loop 102 and the casing 104). A generator 408 (genset—can include control and connections to the generator) is driven through a cable 410 by the hydro turbine 120 to generate electricity. Alternatively, the turbine 120 can have an electrical generator in the form or permanent magnets on an outer edge sweeping around a coiled conductor generating power to be fed through a conductive cable 408 to the surface to power a load. The working fluid 108 operates in a closed loop. The length of the primary loop in the oil well application can be long to match the well, e.g. oil wells can be 10,000 feet plus deep. Height can also be adjusted in the case of a deep well by partially filling the oil well with water to a desired depth.

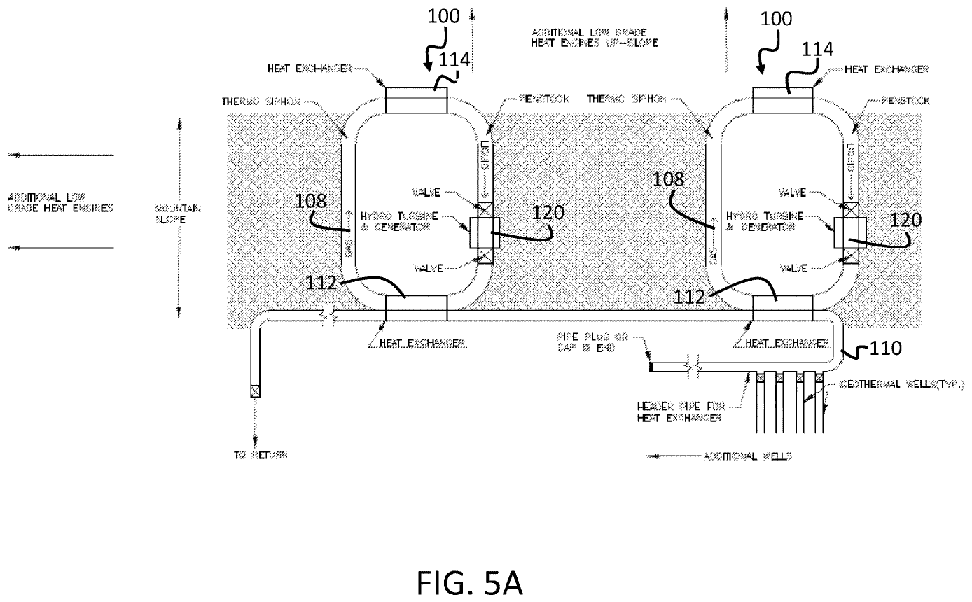

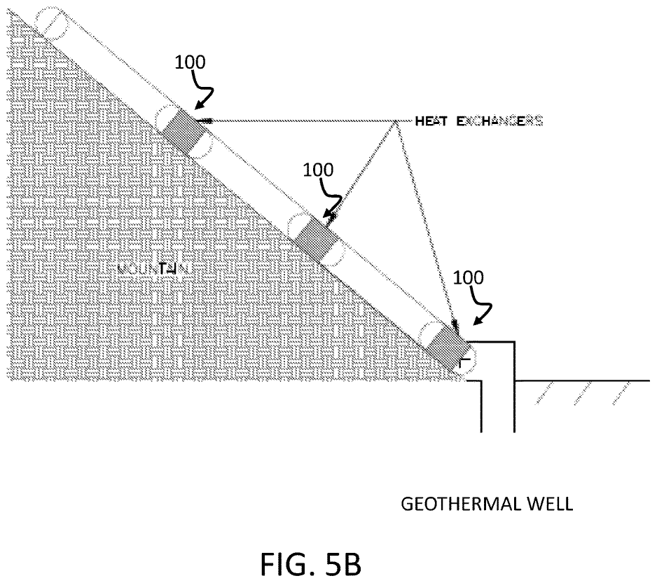

FIGS. 5A & 5B show heat engine systems 100 consistent with FIG. 1 with geothermal wells as low-grade heat sources 110 applied to a mountain or hill slope. FIG. 5A shows details of the heat engine systems 100 and FIG. 5B an example layout for implementation of the 5A system on a slope. The slope provides gravity needed for operation while avoiding the need to build an above ground structure for the gravity needed for the liquid working fluid to supply energy to the hydro turbines 120. Each of the heat engine systems 100 in FIGS. 5A and 5B include only the primary loop 102 from FIG. 1, and the heat exchangers 114 conduct heat transfer from the primary working fluid 108. The primary loop can be approximate the hill or mountain height, or a portion of the height/slope length, such as 50-75% in a preferred embodiment. The total length can be divided into stages, with the loop length or height up the slope is approximately 600 to 800 meters for each stage or loop.

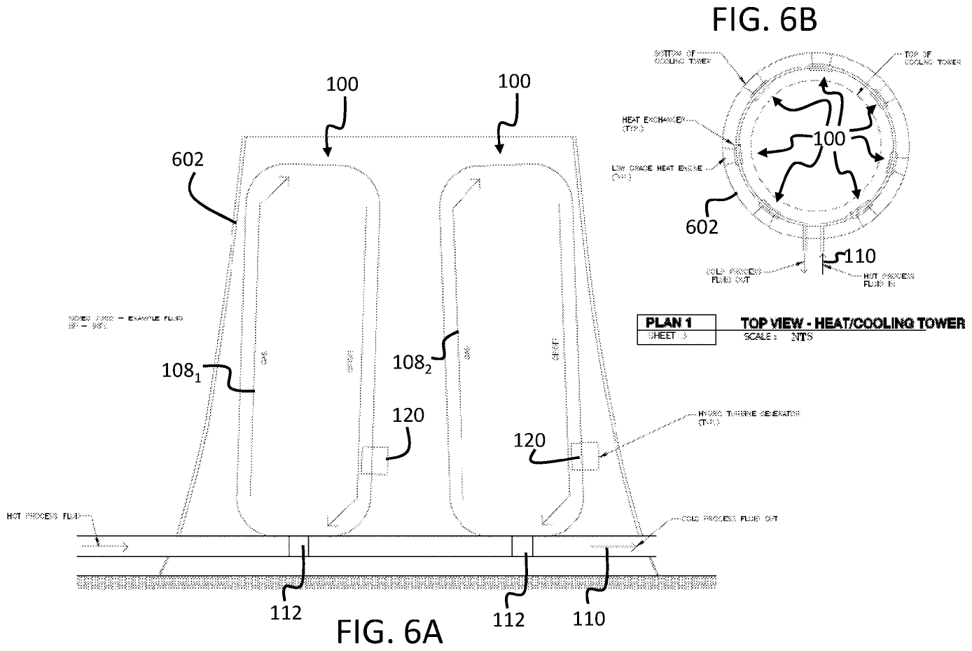

FIGS. 6A and 6B show multiple heat engine systems 100 consistent with FIG. 1 applied in a cooling tower 602. Instead of ejecting steam, the steam or hot fluid serves as the low-grade heat source 110 to provide heat for the primary working fluid 108₁-108ₓ of each system 100, which each has a turbine 120 to generate energy that would otherwise be expelled into the surrounding environment. Multiple cycles of working fluids 108₁-108ₓ can be arranged along the flow line of the coolant, as seen in FIG. 6B each with a successively lower boiling point extract the heat from the coolant. A typical height of each loop in the cooling tower would be 100-200 meters.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A low-grade heat engine system powered by a source fluid containing low-grade heat, the system comprising:
a primary loop containing a primary working fluid, the primary working fluid having a boiling point below the source fluid;
a first heat exchanger configured to transfer heat from the source fluid into the primary working fluid and create a gas phase of the primary working fluid;
a thermosiphon portion of the primary loop arranged to direct the gas phase of the primary working fluid in a direction opposite to gravitational force, a height of the thermosiphon portion being set to the Carnot efficient defined by mgh/(mgh+Enthalpy of vaporization of the primary working fluid), where m is the unit mass of the fluid g is the gravity constant and h is height of the thermosiphon;
a second heat exchanger at an upper portion of the primary loop to extract heat from the gas phase of the primary working fluid and convert the primary working fluid into the liquid phase and
a primary hydro turbine driven by a liquid phase of the primary working fluid as the liquid phase is driven with the gravitational force, wherein the only energy source to the system is the source fluid containing the low-grade heat.

2. The system of claim 1, wherein the primary hydro turbine is below the second heat exchanger in the direction of gravitational force such that gravitational force acting on the liquid phase drives the hydro turbine.

3. The system of claim 2, wherein the primary loop comprises a primary closed loop, the system comprising:
a secondary closed loop containing a secondary working fluid, the secondary working fluid having a boiling point below the primary source fluid, the secondary closed loop being interfaced to the second heat exchanger to recuperate the latent heat of condensation of the first primary working fluid;
a thermosiphon portion of the secondary closed loop is arranged to direct the gas phase of the secondary working fluid in a direction opposite to gravitational force, a height of the thermosiphon portion of the secondary closed loop being set to the Carnot efficient defined by mgh/(mgh+Enthalpy of vaporization of the secondary working fluid), where m is the unit mass of the fluid g is the gravity constant and h is height of the thermosiphon;
a third heat exchanger at an upper portion of the secondary closed loop to extract heat from the gas phase of the secondary working fluid and convert the secondary working fluid into a liquid phase;
a secondary hydro turbine below the third heat exchanger in the direction of gravitational force such that gravitational force acting on the liquid phase drives the hydro turbine; and
a secondary generator generated by the secondary hydro turbine.

4. The system of claim 1, comprising a primary generator driven by the primary hydro turbine.

5. The system of claim 4, comprising a drive cable from the primary hydro turbine to the primary generator.

6. The system of claim 1, wherein the thermosiphon portion of the primary closed loop comprises a heat conducting wall configured to conduct heat from the surrounding environment to the gas phase of the working fluid.

7. The system of claim 1, wherein the thermosiphon portion of the primary closed loop is thermally insulated from the surrounding environment.

8. The system of claim 1, wherein the thermosiphon portion of the primary closed loop comprises a thermally conductive lining thermally coupled to the first heat exchanger.

9. The system of claim 1, wherein the source fluid is gas from a well.

10. The system of claim 9, wherein the well comprises a closed gas or oil well.

11. The system of claim 10, wherein the primary loop comprising an opening that opens toward a plug of the closed gas or oil well, wherein the plug forms the first heat exchanger, wherein a length of the primary loop matches a depth of the gas or oil well or depth of water partially filling the gas or oil well.

12. The system of claim 11, wherein the primary hydro turbine comprises an electrical generator, the system further comprising a conductive cable from the hydro turbine to a load.

13. The system of claim 11, wherein the primary loop is formed by inner tubing inserted in a casing of the well and having the primary hydro turbine in the inner tubing and the thermosiphon portion of the primary loop is formed by a gap between the inner tubing and the casing.

14. The system of claim 13, wherein the primary generator is above ground and is driven by the primary hydro turbine through a cable.

15. The system of claim 1, wherein at least a portion of the primary closed loop is installed underground.

16. The system of claim 1, comprising a series arrangement of the primary loop and one or more secondary loops, wherein each secondary loop is driven by heat exchange from a previous secondary loop or the primary loop, and each consecutive secondary loop comprises a lower boiling point working fluid than the previous secondary loop or the primary loop.

17. The system of claim 16, wherein the primary loop and one or more secondary loops are arranged in a cooling tower, and the source fluid comprises steam or hot fluid from the cooling tower.

18. A system comprising a plurality of low-grade heat engine systems of claim 1 arranged in parallel.

19. The system or claim 18, wherein the plurality of low-grade heat engine systems shares a common source of the source fluid.

20. A system comprising a plurality of low-grade heat engine systems of claim 1 arranged in series.

21. The system of claim 20, wherein the plurality of low-grade heat engine systems are arranged on a slope of a hill or mountain and a height of the thermosiphon portion is in the range of approximately 600 to 800 meters.

22. The system of claim 21, wherein the source fluid comprises one or more geothermal wells.
